(19) United States
(12) Patent Application Publication
(10) Pub. No.: US 2010/0199418 A1
(43) Pub. Date: Aug. 12, 2010

(54) Portable Hair Washer

(76) Inventor: Hyun Tae Yi, Gyeonggi-do (KR)

Correspondence Address: EDELL, SHAPIRO & FINNAN, LLC, 1901 RESEARCH BOULEVARD, SUITE 400, ROCKVILLE, MD, 20850, US

(21) Appl. No.: 12/762,685

(22) Filed: Apr. 19, 2010

Related U.S. Application Data
(63) Continuation of application No. PCT/KR2008/006752, filed on Nov. 17, 2008.

(30) Foreign Application Priority Data
May 27, 2008 (KR) 1020080048914

(51) Int. Cl. A45D 19/04

(52) U.S. Cl. 4/516

(57) ABSTRACT

A portable hair washer permits hair washing of patients who cannot move freely, regardless of the state of the patients or the environment where the patients are located. The portable hair washer includes: a shampoo bowl of depressed shape; a head mounting portion curved to support a patient's head on a side of the shampoo bowl; a reservoir portion separated from the shampoo bowl by a side wall to store water; a drainage portion separated from the reservoir portion by a separation wall to store used water from the shampoo bowl; a water supply portion disposed on a side of the reservoir portion to supply water to the reservoir portion; a shower disposed on a side of the reservoir portion to supply the water to the shampoo bowl; and a pump providing the shower with a driving force to draw the water.

### CROSS REFERENCE TO RELATED APPLICATIONS

This application is a continuation of International Application No. PCT/KR2008/006752, filed on Nov. 17, 2008, entitled “Portable Hair Washer,” which claims priority under 35 U.S.C. §119 to Application No. KR 10-2008-0048914 filed on May 27, 2008, entitled “Portable Hair Washer,” the entire contents of which are hereby incorporated by reference.

### FIELD OF THE INVENTION

The present invention relates to a hair washer, and more particularly, a portable hair washer for washing hair of patients.

### BACKGROUND

Patients who have been seriously sick for a long time, such as people with general paralysis or who cannot sit or walk by themselves due to paralysis, cannot wash themselves. Therefore, family members of the patients or nurses (hereinafter, referred to as nurses) may wash a patient's hair using wet towels in a state where the patient lies down. However, when the hair is washed using the wet towel, the scalp cannot be washed as thoroughly as the hair.

Accordingly, a nurse may move the patient to a bathroom to wash the patient's hair using water. However, a patient who cannot move freely does not keep himself/herself steady; thus, it is very difficult to move the patient. In addition, moving the patient may result in a serious injury to the patient. As described above, it is nearly impossible to move the patient to wash his/her hair. Moreover, it also may be difficult for the nurse to wash the patient's hair using a bowl.

In particular, a nurse often cannot wash the patient's hair adequately as a result of the environment surrounding the patient. For example, a situation may exist in which water cannot be supplied from outside to wash the patient's hair, and there is no equipment for washing the patient's hair whenever desired. Therefore, a device is required for washing a patient's hair whenever desired without regard to the state or condition of the patient or the environment where the patient is located.

### SUMMARY

The present invention provides a portable hair washer, by which a nurse may wash a patient's hair whenever desired, regardless of state of the patient or the environment where the patient is located.

According to an aspect of the present invention, there is provided a portable hair washer including: a shampoo bowl of depressed shape; a head mounting portion that is curved so that a patient's head can be supported on a side of the shampoo bowl; a reservoir portion for storing water, which is divided from the shampoo bowl by a side wall; a drainage portion for storing water that is used in the shampoo bowl, the drainage portion being separated from the reservoir portion by a separation wall and; a water supply portion disposed on a side of the reservoir portion to supply the water to the reservoir portion; a shower for supplying the water to the shampoo bowl, the shower being disposed on a side of the reservoir portion and spaced apart from the water supply portion and; and a pump providing the shower with a driving force to draw the water.

The pump may induce air into the reservoir portion to compress the water. The pump may supply the water to the shower using an electrical mechanism. The pump may compress the water using a bellows that is expanded or extracted by the air.

According to another aspect of the present invention, there is provided a portable hair washer including: a shampoo bowl of depressed shape; a head mounting portion that is curved so that a patient's head can be supported on a side of the shampoo bowl; a reservoir portion for storing water, which is divided from the shampoo bowl by a side wall; a drainage portion for storing water that is used in the shampoo bowl, the drainage portion being divided from the reservoir portion by an inclined separation wall; a buffer for storing some of the water in the reservoir portion, the buffer being disposed on a side of the reservoir portion and the drainage portion; a water supply valve disposed on a side of the reservoir portion to supply the water in the reservoir portion to the buffer; a water supply portion disposed on the buffer to supply the water to the reservoir portion; a shower disposed on the buffer, separated from the water supply portion, to supply the water to the shampoo bowl; and a pump providing the shower with a driving force to draw the water.

The water supply valve may supply the water stored in the reservoir portion to the buffer using operations of a separation plate and a spring. The water supply valve may supply the water stored in the reservoir portion to the buffer by rotating screws.

### BRIEF DESCRIPTION OF THE DRAWINGS

FIG. 1A is a perspective view of a portable hair washer which is partially cut according to an embodiment of the present invention;

FIG. 1B is a cross-sectional view of the portable hair washer taken along line 1B-1B of FIG. 1A, and FIG. 1C is a cross-sectional view of the portable hair washer taken along line 1C-1C of FIG. 1A;

FIG. 2A is an exploded perspective view illustrating a driver included in the portable hair washer;

FIGS. 2B and 2C are cross-sectional views illustrating a pressure application process using the driver;

FIG. 3A is a perspective view of a portable hair washer which is partially cut according to another embodiment of the present invention;

FIG. 3B is a cross-sectional view of the portable hair washer taken along line 3B-3B of FIG. 3A, and FIG. 3C is a cross-sectional view of the portable hair washer taken along line 3C-3C of FIG. 3A.

### DETAILED DESCRIPTION

Embodiments of the present invention will be described in detail with reference to accompanying drawings.

Hereinafter, a portable hair washer, which is used to wash patients' hair regardless of physical states of patients or the environment where the patients are located, is described. The portable hair washer is equipment for washing patients' hair in a place where the patients lie. That is, whenever a patient requests, a nurse may transport the hair washer (e.g., via automobile or the like) and may wash the hair of the patient. Embodiments of the present invention may be classified by types of supply water for washing hair. However, the embodiments may be modified variously within the scope of the present invention.

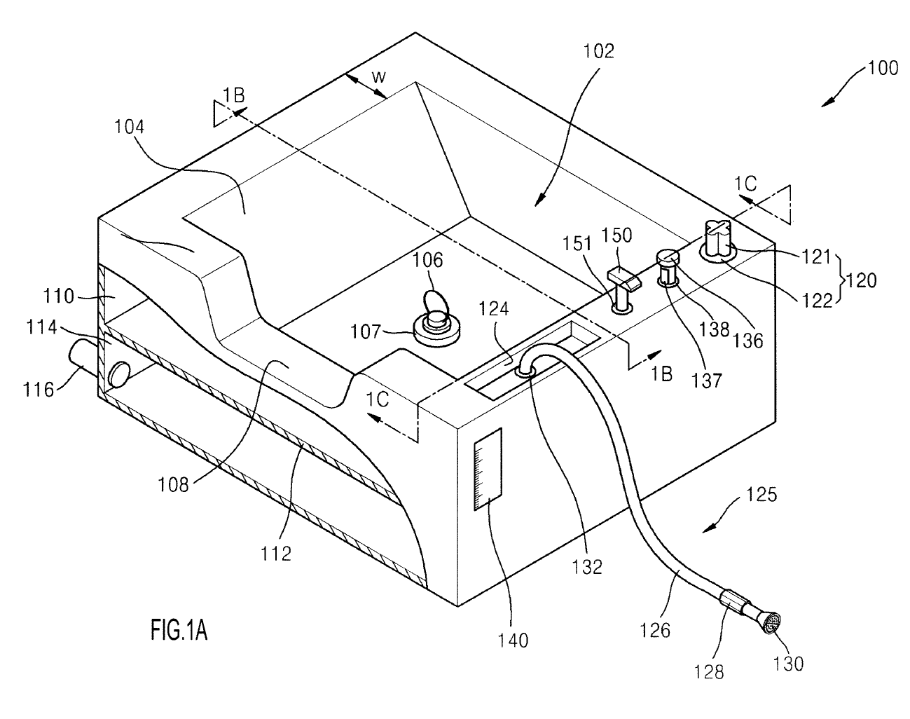

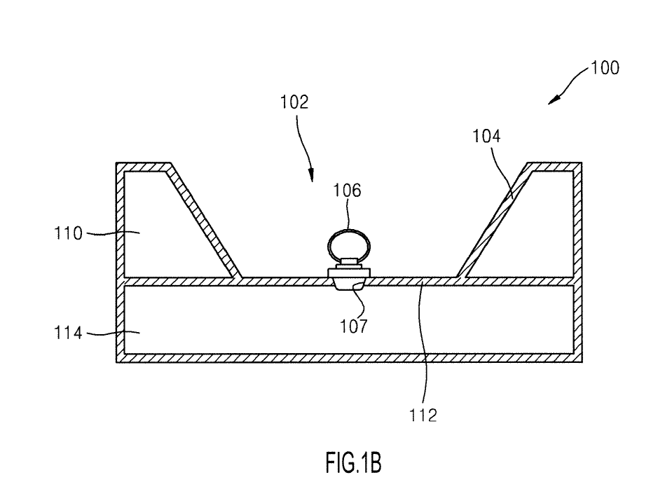

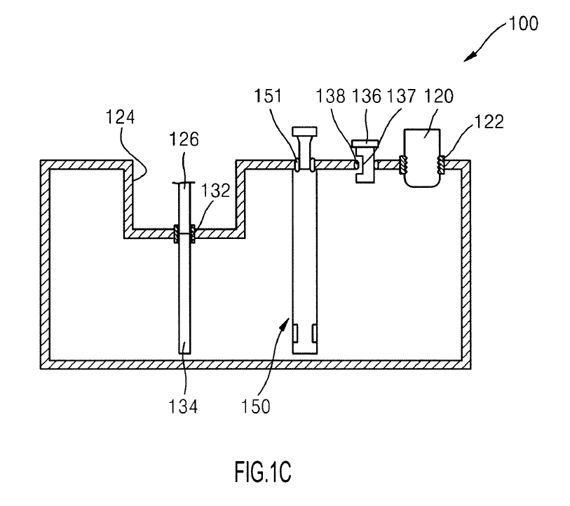

FIG. 1A is a perspective view of a first portable hair washer 100 according to an embodiment of the present invention, and a part of the first portable hair washer 100 is cut for the sake of convenience. FIG. 1B is a cross-sectional view of the first portable hair washer 100 taken along line 1B-1B of FIG. 1A, and FIG. 1C is a cross-sectional view of the first portable hair washer 100 taken along line 1C-1C of FIG. 1A.

Referring to FIGS. 1A through 1C, the interior of the first portable hair washer 100 includes a reservoir portion 110 receiving water for washing hair, and a drainage portion 114 receiving waste water, which are divided by a separation wall 112. The exterior of the first portable hair washer 100 includes a shampoo bowl 102, a water supply portion 120, a ventilation portion 136, a driver 150 (e.g., a pump), and a shower 125.

The shampoo bowl 102, in which the patient's hair is washed, has an entirely depressed structure (i.e., a depression), and includes a head mounting portion 108 that is curved to support the patient's head on a side portion thereof. The head mounting portion 108 is not limited to the example shown in the drawings, and any structure in which the patient's head can be placed comfortably and safely may be used as the head mounting portion 108. For example, a soft rubber may be disposed on a bottom surface of the head mounting portion 108 to fit the shape of the head.

Moreover, the head mounting portion 108 may be fabricated as an additional structure and, for example, may include a tube (not shown) that is expanded by air injection. Here, the tube may be fabricated to be suitable for the patient's head, and the air may be injected in a general way. When the amount of injected air is adjusted, pressure in the tube is changed; accordingly, the tube can be easily fitted to the shape of the patient's head. In addition, the head mounting portion 108 may further include an additional supporting board (not shown) that can support the neck of the patient. The supporting board may be folded on a side wall of the portable hair washer 100 when it is not used, and may be unfolded to support the neck of the patient when the portable hair washer 100 is used.

A side wall 104 of the shampoo bowl 102 may have an inclination that varies depending on an amount of water (hereinafter, supplied water) stored in the reservoir portion 110, and if necessary, the side wall 104 may be perpendicular to the separation wall 112. In addition, a height and a width w of the side wall 104 are also determined according to the amount of supplied water. In order to make the structure of the shampoo bowl 102 simple, a bottom surface of the shampoo bowl 102 may be defined by the separation wall 112. However, the bottom surface of the shampoo bowl 102 may be separately formed from the separation wall 112 in consideration of the entire structure of the hair washer 100.

The water (hereinafter, used water) used to wash the patient's hair in the shampoo bowl 102 flows to the drainage portion 114 through a drain hole 107. That is, during washing the patient's hair, a first packing (e.g., a plug or stopper) 106 that blocks the drain hole 107 is opened to make the used water flow to the drainage portion 114. The first plug 106 may be positioned to maintain the drain hole in the open state during washing of the patient's hair to make the used water flow to the drainage portion 114 continuously; otherwise, washing may be performed while the drain hole is closed by first plug 106 in order to reuse the used water or to wash the patient's hair in a state where the bowl is filled with water. The water is reusable during rinsing of the hair, and after the rinsing process, the drain hole may be opened by displacement of first plug 106 to discharge the water to the drainage portion 114. Accordingly, the bottom surface of the shampoo bowl 102 may be inclined toward the drain hole 107. The first plug 106 is to block the flow of water, and a screw-shaped plug may be used as the first plug 106.

The water supply portion 120 supplies water to the reservoir portion 110 or discharges remaining water, and is opened/closed by rotating a manual lever 121 or by using pressure. When the water supply portion 120 is opened/closed due to rotation, the water supply portion 120 may include a first coupling portion 122 that is formed as a screw to operate the manual lever 121. When the water supply portion 120 is opened/closed due to pressure, the first coupling portion 122 is not required; however, a packing or plug (not shown) for attaching the manual lever 121 may be further installed. A size of the water supply portion 120 may be determined in consideration of the entire size and shape of the first portable hair washer 100.

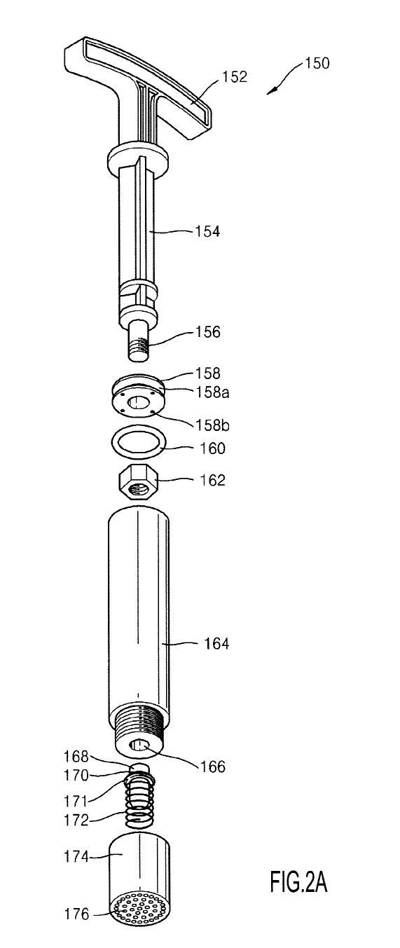

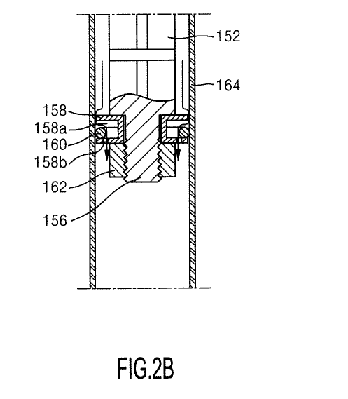

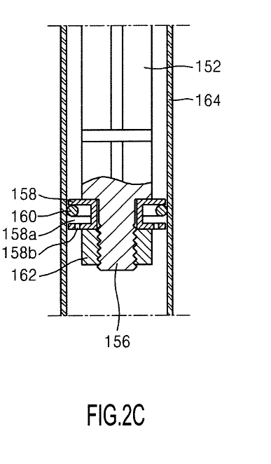

The driver (pump) 150 applies pressure to the water received in the reservoir portion 110 so as to discharge the water to the outside. That is, the pressure applied to the water received in the reservoir portion 110 is increased by operation of the pump 150, and the increased pressure makes the water received in the reservoir portion 110 discharge out of the reservoir portion 110 through the shower 125. The structure and functions of the pump 150 will be described in more detail with reference to FIGS. 2A through 2C. The increased pressure in the reservoir portion 110 may be released by the ventilation portion 136. The pump 150 may include a second packing 151 (e.g., a seal) in order to improve a sealing property.

The shower 125 is coupled to a water absorption tube 134, which extends toward the inside of the reservoir portion 110, via a second coupling portion 132, and includes a hose 126, an opening/closing portion 128, and a shower head 130. The shower 125 is received in a shower receiving recess 124, and the hose 126 and the shower head 130 are well known in the art. The opening/closing portion 128 adjusts the amount of water of the reservoir portion 110 discharged through the shower head 130. When the opening/closing portion 128 is opened, the water is supplied, and when the water is not required, the opening/closing portion 128 is closed to stop the supply of water. The opening/closing portion 128 may operate in various ways, for example, the opening/closing portion 128 may be pushed to make the water flow or may be twisted manually to make the water flow.

The ventilation portion 136 includes a ventilation window 137 on a side thereof. When the ventilation portion 136 is pulled to expose the ventilation window 137, external air is induced into the reservoir portion 110 through the ventilation window 137 to make the pressure in the reservoir portion 110 equal to atmospheric pressure. When the ventilation portion 136 is pushed to close the ventilation window 137, the pressure applied to the water in the reservoir portion 110 is maintained. Here, a third packing 138 (e.g., a seal) may be installed to seal the ventilation portion 136.

A water amount display 140 may be formed on the side wall of the reservoir portion 110 so as to check the amount of water received in the reservoir portion 110, and a discharge portion 116 is located on a lower portion of the drainage portion 114 so as to discharge the used water stored in the drainage portion 114. The water amount display 140 is formed by marking scales on a transparent window, and the discharge portion 116 has a similar structure to that of the water supply portion 120. That is, the discharge portion 116 may be opened/closed using rotation or pressure.

FIG. 2A is an exploded perspective view of the pump 150, and FIGS. 2B and 2C are cross-sectional views illustrating pressure application operation of the pump 150. In the drawings, arrows denote the flow of air.

Referring to FIGS. 2A through 2C, the pump 150 includes a compression bar 154 that moves to inject air into the reservoir portion 110, and a cylinder 164 into which the compression bar 154 is inserted. A handle 152 is formed on an upper portion of the compression bar 154 that is inserted in the cylinder 164, and a bolt 156, onto which a piston 158 is inserted, protrudes out of a lower portion of the compression bar 154. A nut 162 is coupled to the bolt 156 for preventing the piston 156 from disengaging from the bolt 156. The piston 158 includes a ring recess 158a and a first through hole 158b, and an O-ring 160 is inserted in the ring recess 158a so as to move in upward and downward directions.

When the compression bar 154 is pulled to the handle 152 side, air is induced into the first through hole 158b after passing through the piston 158 and the cylinder 164. In addition, when the compression bar 154 is pushed toward the opposite direction, the induced air enters the reservoir portion 110 and the air passage is blocked (refer to FIGS. 2B and 2C).

On the other hand, a second through hole 166, in which a movable bar 168 is inserted, is formed on a lower portion of the cylinder 164. The movable bar 168 has a prevention step 171 for restricting a degree of insertion of the movable bar 168 into the second through hole 166, and an O-ring 170 is formed on the prevention step 171 for sealing. A spring 172 is installed on a side of the prevention step 171 of the movable bar 168. The movable bar 168 is inserted into the second through hole 166, and a first cover 174 having third through holes 176, which make the air flow toward the bottom surface of the reservoir portion 110, is fixed on the lower portion of the cylinder 164 using a screw. Here, the manner of fixing the first cover 174 to the cylinder 164 is not limited to the screw.

When air is induced due to operation of the compression bar 154, a difference between pressures inside and outside the cylinder 164 is generated, and the driving force generated by the pressure difference moves the movable bar 168 toward the reservoir portion 110. Accordingly, the movable bar 168 and the second through hole 166 are separated, and the air is discharged to the reservoir portion 110 through the third through holes 176. When the force applied to the compression bar 154 is released, the spring 172 returns the movable bar 168 to the original position, and the air flowing between the first through hole 166 and the movable bar 168 is blocked. At this time, the O-ring 170 clearly blocks the flow of the air.

The patient's hair can be washed using the first portable hair washer 100 according to the present invention through the following processes. First, the water supply portion 120 is opened in a state of blocking the first plug 106 to fill the reservoir portion 110 with water, and then the water supply portion 120 is closed. After that, the patient lays his/her head onto the head mounting portion 108. In a state where the ventilation portion 136 is closed, pressure is applied to the reservoir portion 110 using the pump 150. In addition, the required amount of water is supplied to the patient's hair by opening the opening/closing portion 128 of the shower 125; then, the opening/closing portion 128 is closed. After shampooing the patient's hair, the hair is rinsed off using the shower after opening the opening/closing portion 128. Here, the used water can be drained to the drainage portion 114 or can remain in the shampoo bowl 102. If the used water remains in the shampoo bowl 102, the first plug 106 is opened to allow the used water to flow to the drainage portion 114. Once all of the used water has flowed to the drainage portion 114, the discharge portion 116 is opened to discharge the used water to the outside.

According to the portable hair washer of the present invention, the equipment for washing the patient's hair is portable; thus, it can be used regardless of the state of the patient or the environment where the patient is located. That is, when the patient wants to wash, a nurse can wash the patient's hair using the portable hair washer of the present invention without moving the patient. Since the only thing the patient has to do is place his/her head on the head mounting portion of the portable hair washer, the patient does not feel any inconvenience caused by the movement and can be protected from any physical harm.

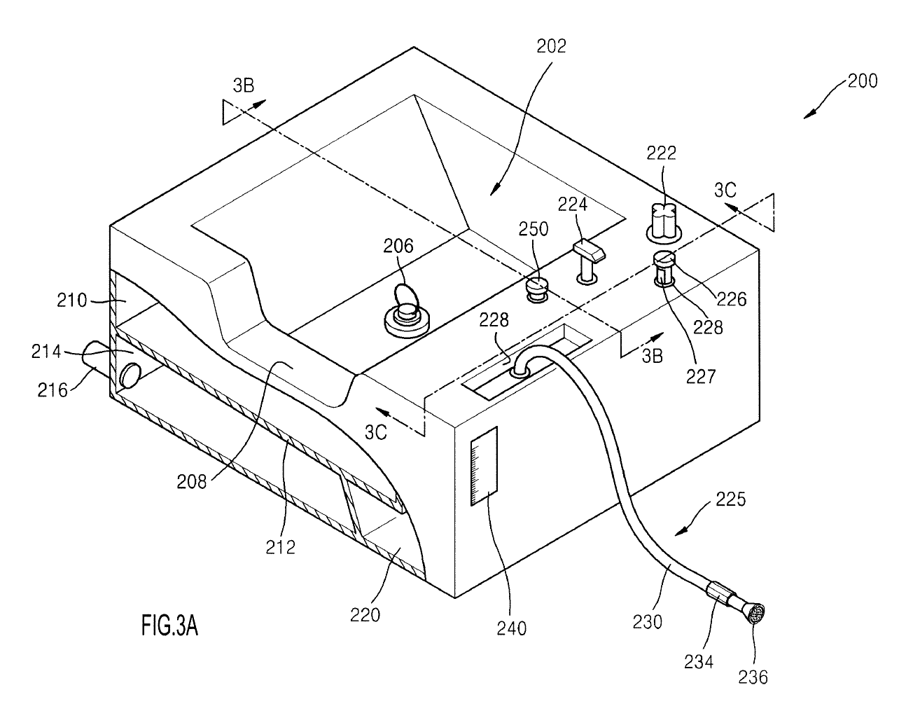

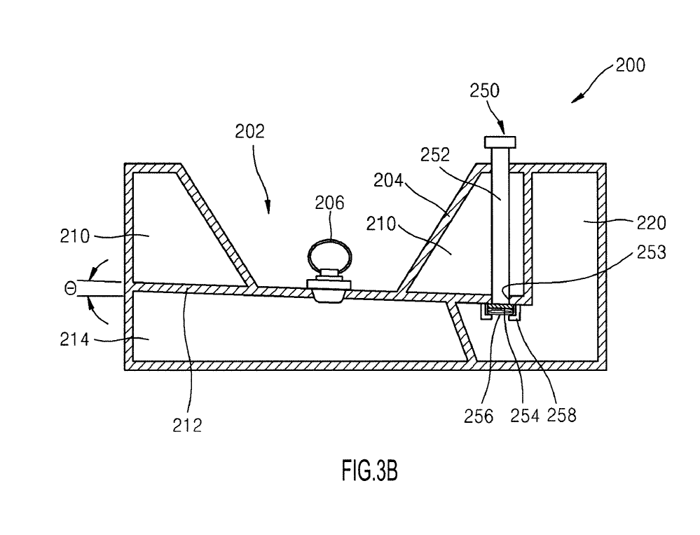

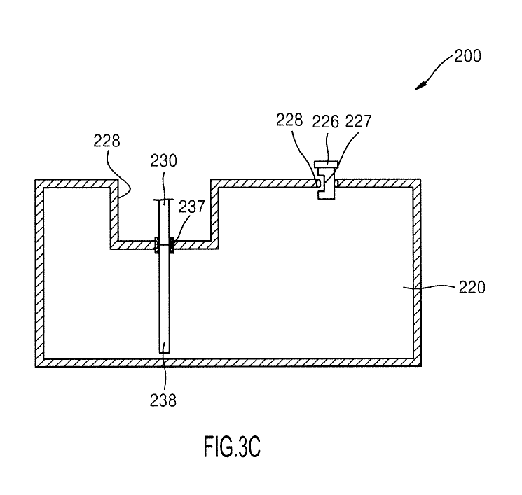

FIG. 3A is a perspective view of a second portable hair washer 200 according to another embodiment of the present invention, and a part of the second portable hair washer 200 is cut for the sake of convenience. FIG. 3B is a cross-sectional view of the second portable hair washer 200 taken along line 3B-3B of FIG. 3A, and FIG. 3C is a cross-sectional view of the second portable hair washer 200 taken along line 3C-3C of FIG. 3A. Here, a shampoo bowl 202, a first packing (plug) 206, a head mounting portion 208, a discharge portion 216, a water supply portion 222, a driver (pump) 224, a shower 225, a ventilation portion 226, and a water amount display 240 are respectively similar to the shampoo bowl 102, the first plug 106, the head mounting portion 108, the discharge portion 116, the water supply portion 120, the pump 150, the shower 125, the ventilation portion 136, and the water amount display 140 in the first portable hair washer 100 described with reference to FIGS. 1A through 1C. Accordingly, detailed descriptions of the above elements are omitted.

Referring to FIGS. 3A through 3C, the second portable hair washer 200 is different from the first portable hair washer 100 in view of a reservoir portion 210, a drainage portion 214, a buffer 220, and a water supply valve 250. In more detail, the reservoir portion 210 and the drainage portion 214 are divided by a separation wall 212 that is inclined at an angle θ, and the buffer 220 is located at a side of the reservoir portion 210 and the drainage portion 214, where the pump 224 and the shower 225 are installed.

The reservoir portion 210 is inclined at the angle θ so that the water stored in the reservoir portion 210 flows toward the buffer 220. The water supply valve 250 includes a support bar 252, a separation plate 254, a spring 256, and a second cover 258. The support bar 252 moves while being inserted in a flow path 253 formed in the separation wall 212, and the separation plate 254 is attached on a side of the support bar 252 that contacts the buffer 220.

When a force is applied to the support bar 252 toward the reservoir portion 210, the separation plate 254 moves toward the buffer 220 and the flow path 253 is opened, and then the water stored in the reservoir portion 210 flows to the buffer 220. Accordingly, the water starts to fill the buffer 220. The amount of supplied water can be checked using the water amount display 240 formed in the side wall of the buffer 220. When the force applied to the support bar 252 is released, the separation 254 is returned to the original position by the spring 256, and the flow path 253 is closed.

Here, the flow of supplied water is adjusted using the separation plate 254 and the spring 256; however, the flow of water can be adjusted in various ways. For example, a screw may be formed on the flow path 253 and an end of the support bar 252; then, the flow of water can be adjusted by rotating the screw.

The second portable hair washer 200 of the present embodiment can apply sufficient pressure to the water, because the amount of supplied water is limited and the pressure of water injected through the shower 225 can be adjusted appropriately. In addition, the water required in the washing can be appropriately distributed.

In the embodiments of the present invention, the water is supplied to the shower using a compression method; however, the water can be supplied in various ways. For example, the water can be supplied using an electrical mechanism. Here, the opening/closing portion that supplies the water and blocks the water supply to the shower can be driven electrically. Otherwise, the pressure can be adjusted using a bellows that can be expanded and extracted. In more detail, the bellows is installed in the reservoir portion 110 or the buffer 220, and air is injected into the bellows to expand the bellows. Then, the pressure applied to the water in the reservoir portion 110 or the buffer 220 can be increased.

According to the portable hair washer of the present invention, the equipment for washing the patient's hair is portable; thus, it can be used regardless of the state of the patient or the environment where the patient is located. That is, when the patient wants to wash, a nurse can wash the patient's hair using the portable hair washer of the present invention without moving the patient. Since the only thing the patient has to do is place his/her head on the head mounting portion of the portable hair washer, the patient does not feel any inconvenience caused by the movement and can be protected from any physical harm.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A portable hair washer, comprising:
a shampoo bowl of depressed shape;
a head mounting portion disposed on a side of the shampoo bowl and curved to support a patient's head;
a reservoir portion separated from the shampoo bowl by a side wall and configured to store water;
a drainage portion separated from the reservoir portion by a separation wall and configured to store used water from the shampoo bowl;
a water supply portion disposed on a side of the reservoir portion and configured to supply water to the reservoir portion;
a shower disposed on a side of the reservoir portion, and spaced apart from the water supply portion, and configured to supply water to the shampoo bowl; and
a pump configured to provide the shower with a driving force to draw water.

2. The portable hair washer of claim 1, wherein a bottom surface of the shampoo bowl is defined by the separation wall.

3. The portable hair washer of claim 1, wherein the pump induces air into the reservoir portion to pressurize the reservoir portion.

4. The portable hair washer of claim 1, wherein the pump supplies water to the shower using electricity.

5. The portable hair washer of claim 1, wherein the pump comprises a bellows.

6. A portable hair washer comprising:
a shampoo bowl of depressed shape;
a head mounting portion disposed on a side of the shampoo bowl and curved to support a patient's head;
a reservoir portion separated from the shampoo bowl by a side wall and configured to store water;
a drainage portion separated from the reservoir portion by an inclined separation wall and configured to store used water from the shampoo bowl;
a buffer disposed on a side of the reservoir portion and the drainage portion and configured to store some of the water in the reservoir portion;
a water supply valve disposed on a side of the reservoir portion and configured to supply water in the reservoir portion to the buffer;
a water supply portion disposed on the buffer and configured to supply water to the reservoir portion;
a shower disposed on the buffer, and spaced apart from the water supply portion, and configured to supply water to the shampoo bowl; and
a pump configured to provide the shower with a driving force to draw water.

7. The portable hair washer of claim 6, wherein the water supply valve comprises a spring and a separation plate biased by the spring to cover an opening between the reservoir portion and the buffer portion, the water supply valve supplying water stored in the reservoir portion to the buffer via displacement of the separation plate.

8. The portable hair washer of claim 6, wherein the water supply valve supplies water stored in the reservoir portion to the buffer by rotating screws.

9. The portable hair washer of claim 6, wherein the pump induces air into the reservoir portion to pressurize the reservoir portion.

10. The portable hair washer of claim 6, wherein the driver supplies water to the shower using electricity.

11. The portable hair washer of claim 6, wherein the pump comprises a bellows.
